(19) United States
(12) Patent Application Publication
(10) Pub. No.: US 2003/0084035 A1
(43) Pub. Date: May 1, 2003

(54) Integrated search and information discovery system

(76) Inventor: Charles L. Emerick III, South Haldley, MA (US)

Correspondence Address: McCormick, Paulding & Huber, City Place II, 185 Asylum Street, Hartford, CT, 06103-3402, US

(21) Appl. No.: 10/200,608

(22) Filed: Jul. 22, 2002

Related U.S. Application Data
(60) Provisional application No. 60/307,261, filed on Jul. 23, 2001.

(51) Int. Cl. G06F 7/00

(52) U.S. Cl. 707/3

(57) ABSTRACT

An integrated search and information discovery system is disclosed. The simultaneous and integrated access to a dynamic plurality of arbitrary search services and data stores is enabled, relieving users of such services and stores from the time-consuming task of accessing them individually or in otherwise inefficient manners. Further, a user-oriented derivative of the common webcrawling process is introduced and utilized to discover information not held in or indexed by the accessed search services and data stores using content and links delivered by those search services and data stores in response to an integrated user query. Finally, a modular information analysis framework is utilized to allow for the use of a plurality of information analysis methods depending on the needs of a user.

### CROSS REFERENCE TO RELATED APPLICATION

This application claims the priority benefits of copending U.S. Provisional Application No. 60/307,261, filed on Jul. 23, 2001.

### STATEMENT REGARDING FEDERALLY SPONSORED RESEARCH OR DEVELOPMENT

Not Applicable

### FIELD OF THE INVENTION

This invention relates to the field of search and information retrieval. Specifically, the present invention relates to a process and system that enables a user: (a) to dynamically integrate arbitrary types of search services and data stores into a search for simultaneous access and querying, and (b) to apply webcrawling techniques and processes to a restricted set of qualified content so as to avoid common pitfalls when working with current search technologies.

### BACKGROUND OF THE INVENTION

Information may be stored and distributed in many diverse ways given the current proliferation of electronic computing devices and ways in which to network and connect those devices so that information may be transmitted between them. These connected collections of electronic devices often contain vast stores of information, usually organized into discrete documents. (The World Wide Web is one example of a connected collection of electronic devices; your personal computer system is another, with its connected set of storage and processing subsystems.) Understandably, the users of these electronic devices often wish to find a particular document or a set of documents that match a given set of criteria. Searching for specific information in this way may be accomplished using any of the hundreds of search utilities, search engines, indexing and database tools, or browsing utilities available today. All of these approaches (which are hereafter collectively referred to as search services and data stores) share a common set of technical and usage characteristics that must be understood prior to considering the current invention's approach.

The methods and processes currently available for performing non-trivial information searches are largely identical in scope, construction, and strategy. First, a search service or other data store must gather a collection of information; this may occur in one step (especially with smaller, well-defined collections), or continuously over time (if the collection is particularly large or difficult to analyze—the World Wide Web is a good example of this). This is the most critical step in the entire process, in that it defines the scope within which any searches over the gathered collection must operate. To illustrate this, consider a collection of information that contains nothing about India; any queries about India made to a service based on that collection will immediately fail. share a common set of technical and usage characteristics that must be understood prior to considering the current invention's approach.

The methods and processes currently available for performing non-trivial information searches are largely identical in scope, construction, and strategy. First, a search service or other data store must gather a collection of information; this may occur in one step (especially with smaller, well-defined collections), or continuously over time (if the collection is particularly large or difficult to analyze—the World Wide Web is a good example of this). This is the most critical step in the entire process, in that it defines the scope within which any searches over the gathered collection must operate. To illustrate this, consider a collection of information that contains nothing about India; any queries about India made to a service based on that collection will immediately fail.

In the case of the World Wide Web, which is possibly the largest collection of information, building a collection of information is almost always done by employing some sort of webcrawling process. This process begins with a small sample of documents from the web that contain links, bits of meta-data that describe the location of other documents that are usually related or associated with the document containing the links. The webcrawling process attempts to follow every link that exists within those documents to find new documents, repeating the same process for the set of new documents. This variety of webcrawling, by far the most widespread, is monolithic in its operation: in general, it does not attempt to determine whether a particular document is “worth” adding to the collection being built, because the process cannot have any parameters describing what is “worthwhile”. After all, the process does not know what users will be searching the gathered collection for.

(It is possible to qualify or disqualify documents when building a collection of information, but doing so must restrict the collection to those documents clearly related to a specific topic of interest thereby minimizing the scope of the collection dramatically.)

This collection of information is then analyzed and indexed. The indexing process involves taking a “snapshot” of the structure of each item in the collection, and saving the plurality of snapshots into a database where they may be accessed rapidly. Once an index is built, the search service or other data store must simply provide an interface to it so users may query the index.

A variation on prototypical search services is manifested in the concept of a metasearch engine. A typical metasearch engine does not build or maintain an index; rather, it acts as a front-end to a plurality of search services or data stores, allowing a user query to be distributed to that plurality, with applicable results from that group returned to the user. Metasearch engines are nearly uniform in that the set of search services and data stores that they operate over is static, at least from the user's perspective.

Regardless of what sort of search service or data store is used to locate information, the process from a user's perspective is essentially identical from one instance to another. First, he or she submits a query to a search service or data store, which, after consulting its index(es), returns a set of results containing links to information that is supposed to be qualified with regard to the user's query. Then the user must manually activate or open each link and determine the true level of qualification of each link's associated document(s). Finally, the user must manually (and for an indefinite period of time) follow additional links held in the found documents in order to either discover additional qualified documents that were not returned by the search service or data store, or to discover documents that are qualified to a greater degree.

### STATEMENT OF SHORTCOMINGS OF PRIOR ART

Two fundamental shortcomings affect all methods and processes designed to allow a user to find qualified information efficiently. The first is that virtually all of those methods and processes rely on querying essentially static databases that index content that is located (either spatially, logically, or topically) where the indexing algorithm believes that qualified information may exist. This is ideal for sets of static content, but as the influence of the Internet and other networking technologies grows, so does the tendency for content to be dynamic, fluid, everchanging in both form and substance. Put simply, indexing algorithms and current (and foreseeable) database technology cannot keep pace with the rate of flux that occurs in certain information collections; the World Wide Web and the Internet as a whole is the best example of this phenomenon currently, but it is reasonable to expect that as the pervasiveness of networking technologies expands and accelerates, other information collections that aren't necessarily associated with the Internet will become similarly difficult to track and catalogue using current and foreseeable indexing and database technology. Based on current growth and flux trends observed in both Internet content and in other information collections, this has been the nearly unanimous judgment of essentially every analyst that has examined the problem.

To exemplify this shortcoming more concretely, one needs only to consider current web search engines. Marvels of database and indexing technology, they are nonetheless far behind in cataloging the entirety of the World Wide Web, and they are falling further behind every day: with the size of the World Wide Web estimated to be growing at a rate upwards of 500% per year and advances in database and indexing technology sure to be unable to match such velocity, search engines are forced to concentrate their activities on content that is most likely to be needed by their particular set of users in the near future. In addition, the rapid pace of change of that content means that web search engines are constantly using out of date indexes of that content: the frequency of irrelevant search results and “dead links” pointing at content that no longer exists is testimony to that fact.

A secondary consequence of this first shortcoming is that because current search systems do not (and often cannot) deliver to a user links to all content that may satisfy a user query because of their inability to keep pace with the rapid flux of that content, a user is often required to engage in very time-consuming and tedious manual searching. This manual searching usually involves querying a search service, examining the content delivered by the search service in response to a user query (either directly or via indirect links), and following additional links in that content to find more qualified content that was not delivered by the search service due to indexing limitations. This process often is iterative, with the user following links to (hopefully) additional qualified content through many “levels” of such links. This is widely considered to be a productivity-draining and ineffective searching method, but one that is very necessary given the limitations of indexing and database technology in relationship to the rate of flux of content sought by users.

The second fundamental shortcoming affecting current methods and processes designed to allow a user to find qualified information efficiently is best described as index Balkanization. Search services, which include web search engines, specialized subscription-based services, and other databases of all sorts, are very fragmented, preventing a user from efficiently utilizing a set of search services instead of just one or a couple. This is significant in that each search service is very unique in the content that it catalogues and provides access to; even in the realm of the World Wide Web, where every search engine potentially has access to the same set of information, there is surprisingly very little overlap in what content is examined and catalogued by those search engines. Therefore, in order to effectively search multiple stores of information, a user must manually (and at great expense in terms of time, effort, and possibly cost) access each search service in turn.

Metasearch engines and services have attempted to address this problem to some extent, but their general approach is also insufficient for two reasons: (a) metasearch engines and services (in practice) query a very select and limited subset of the possible search services that the metasearch engine might have access to (which are almost always internet-based, ignoring other possible search services), and (b) no metasearch engine currently allows a user to customize and extend the engine so that it accesses a set of search services entirely of the user's choosing. This becomes a very difficult barrier when a user wishes to utilize metasearch techniques and methods to make searching some personally-chosen set of search services more efficient. An example of this might be a doctor that wishes to access with a single query a set of web search engines, the medical database PubMed, and a local database containing research data. No solution is currently available for such a need.

It is clear that a new information search method must be put forward that can address these shortcomings such that users may conduct non-trivial searches over a plurality of search services and data stores and further refine and prosecute those searches in an automated way, negating the need for time-consuming manual searching.

### SUMMARY OF THE INVENTION

The current invention seeks to remedy the above shortcomings of current search methods and processes by advancing three new variations and improvements upon existing search methods.

The first advance is the specification of a metasearch process that (a) is not limited to internet search services and data stores, enabling users to include diverse information collections in their searches, such as subscription information services (i.e. Lexis-Nexis, Ovid, library catalogs), private databases, or local storage devices, and (b) is customizable and extendable, enabling users to specify how to access and query the aforementioned diverse information collections.

The second advance is the specification of a new webcrawling process that (a) is not limited to functioning within the confines of the World Wide Web, but rather can access documents and extract and follow links over a diverse set of communications methods connecting a diverse set of information storage mediums, and (b) is user-centric, in that it operates in real-time upon the submission of a user query, and only crawls documents that can be qualified with regard to the parameters specified in the user query.

The third advance is the merging of the aforementioned metasearch and webcrawling processes into a single search and information discovery system that enables users to utilize the results and output of the metasearch process as the starting point(s) for the webcrawling process.

Other features of the present invention will be apparent from the accompanying figures and from the detailed description that follows.

An embodiment of the current invention has been commercialized in the form of a product called the Gemini Unified Datamining System, developed and distributed by Snowtide Informatics Systems, Inc. of South Hadley, Mass.

### BRIEF DESCRIPTIONS OF THE FIGURES

FIG. 1 illustrates the top-level architecture of the described embodiment of this invention.

FIG. 2 illustrates the functional interaction between a user and the described embodiment of this invention, as well as the components of the functional interface between the user and and said embodiment.

FIG. 3 illustrates the functionality of the Query Manager, which coordinates all processes of the described embodiment of this invention.

FIG. 4 illustrates the top-level functionality of the Outside Index Query Module, a component of the described embodiment of this invention.

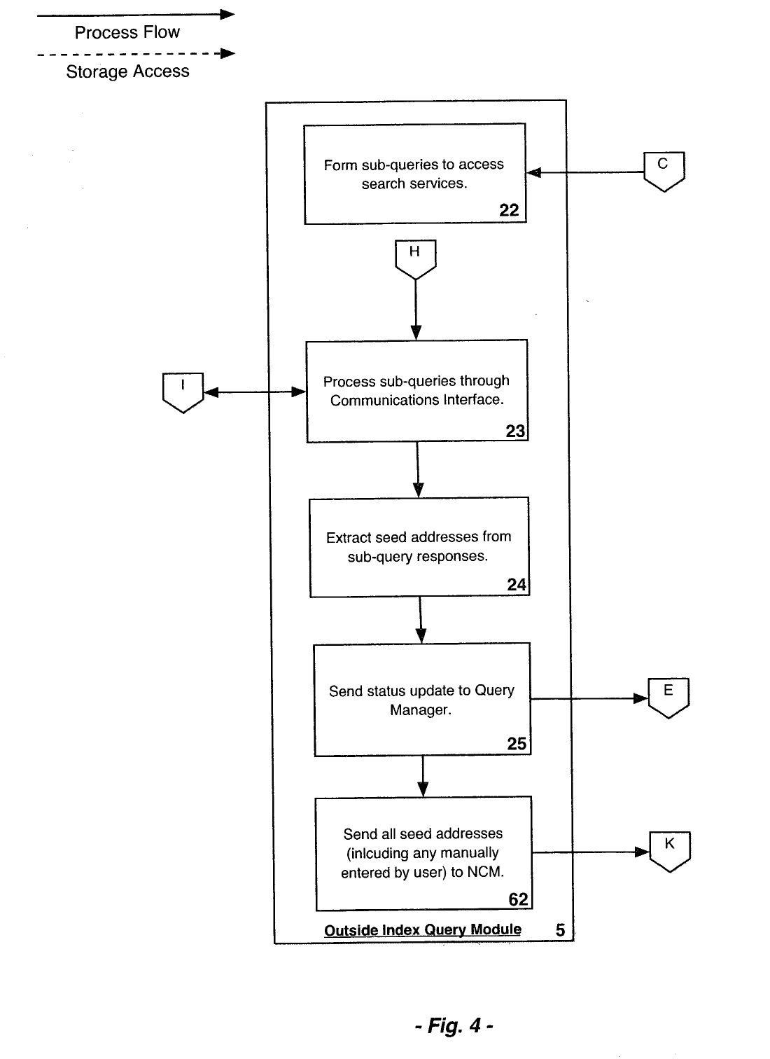

FIG. 5 illustrates the operation of the Communications Interface and the Evaluation Module, two components of the described embodiment of this invention.

FIG. 6 illustrates the operation of the Network and Crawling Module, a component of the described embodiment of this invention.

FIG. 7 illustrates the operation of a critical sub-component of the Outside Index Query Module, a component of the described embodiment of this invention.

### DETAILED DESCRIPTION OF THE PREFERRED EMBODIMENT

The embodiment of an integrated search and information discovery system according to the present invention are hereinafter described in detail with reference to the accompanying figures.

The terms used in the description of the preferred embodiment as well as the remainder of this disclosure are defined as follows:

Link: Any reference to a body of content. Links are often found within content, thereby enabling bodies of content to cross reference other bodies of content. Common embodiments of links include (but are not limited to) World Wide Web hyperlinks and database references.

Content: Any human-readable or—viewable data stored in a digital medium that often serves to communicate information in a structured form. Content includes (but is not limited to) written material as well as visual and audible material.

Meta-Data: Any data that is associated with a body of content in order to describe the state, disposition, source, destination, or other structured properties of said content. Meta-data can include (but is not limited to) properties such as when a body of content was created, when it was modified, when it was transmitted, who or what authored it, how much storage space it occupies, and links to related content.

User Query: Information that is manually inputted by a user that consists of parameters defining or indicating what type or form of content said user wishes to find. Additional parameters may be related to the system that processes the user query.

Data Store: A static collection of data that either contains or refers to content using links. Data stores are usually inert, requiring an independent agent to process the data store's contents. Data stores that are not inert are usually referred to as search services (see below). Examples of data stores include (but are not limited to) standalone databases, indexes of content unaccompanied by systems to process said indexes, and electronic storage devices such as hard disks, tape drives, and memory systems.

Search Service: Any data store that, when presented or sent a user query, responds with content holding links to other content that is deemed to be consistent with the parameters of said user query. Search services are inherently dynamic, able to respond to interaction and requests from external agents without said agents participating in the creation of said response. Search services almost always are grounded in one or many indexes, which are the source of the raw data forming said response. Search engines are the most common embodiment of search services (although other embodiments are possible).

Webcrawling: The process of iteratively and cyclically following links embedded in bodies of content in order to discover (and usually process in some way) other bodies of content. Webcrawling can operate over any set of content held in any electronic medium that supports the semantics of links; while webcrawling is traditionally and originally associated with the processing of content on the World Wide Web, within the scope of this disclosure no assumptions should be made as to what electronic medium holds the content that is to be processed, nor as to the protocols or communications methods used to transmit said content.

Crawling: See ‘Webcrawling’.

Index: A representation of a set of bodies of content that may be rapidly searched. Indexes are almost always built using some variation of webcrawling.

User Interface: Any method or apparatus that enables a user of the current invention to interact with said invention's parameters, controls, and outputs.

Evaluation: Any analysis method with a goal of qualifying content in accordance with the parameters of a user query.

Qualified: A possible state of a body of content as determined by evaluation of said content whereby said content satisfies the minimum requirements of a user query's parameters.

Database: Any organized collection of data.

Seed Address: A representation of a particular link; groups of seed addresses are used to initialize the webcrawling process.

Thread: An independently-operating process of execution within a computer system.

Sub-Query: Data and/or instructions derived from a user query and information about the syntax and protocol of search services and data stores that, without any additional external procedural information, enable a system to interact with said search services and data stores in an abstracted way.

Template Query: An intermediary structure used to create a sub-query. A template query is a framework that describes how to access a given search service or data store. A sub-query is created when a template queries “blanks” are filled with properties from a user query. An example of a template query for a web search engine might be: http://www.search.com/r=5&keywords=**, where ‘**’ is the blank that must be filled with user query-specific parameters in order to effectively access the search engine in accordance with said user query. Template queries may be built using any language or protocol compatible with the target set of search services or data stores, including (but are not limited to) SQL statements, Remote Procedure Calls, and Simple Object Access Protocol requests.

Module: A component of a software process that is complete in and of itself that can accomplish a certain task or process without depending on external processes or components. A module is replaceable, given additional modules that can accomplish said task or process.

Iteration: A single cycle of operation of a webcrawling process, consisting of the steps of locating bodies of content referred to by seed addresses, retrieving said bodies of content, extracting links to additional content from some or all said bodies of content. The newly-extracted links are then used as seed addresses for another iteration.

Network: A collection of computing devices that can communicate between themselves.

Block: A single functional sub-process.

Next, the preferred embodiment of the present invention is described in detail.

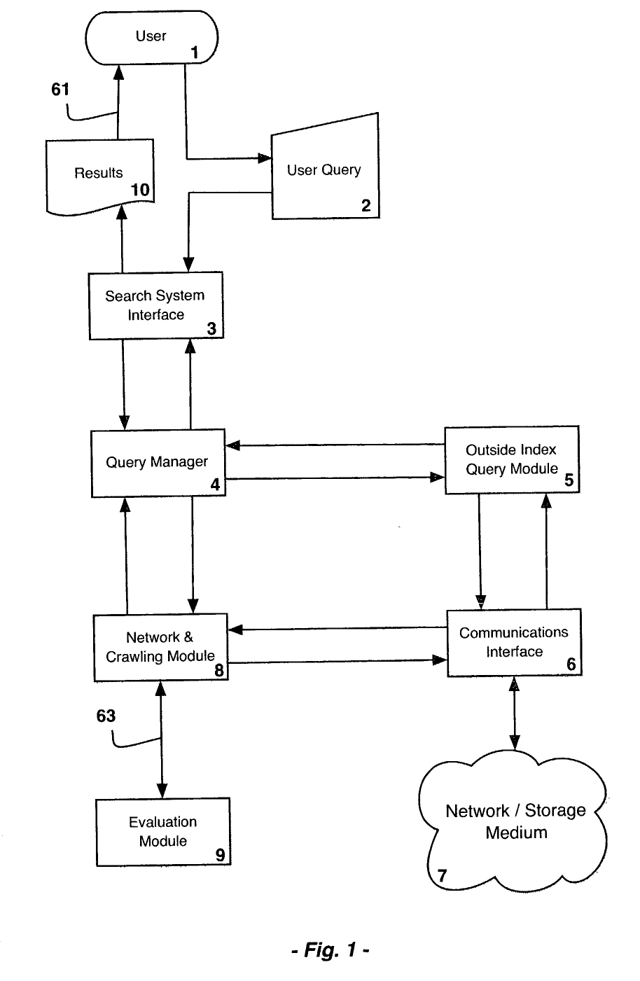

FIG. 1 illustrates the top-level architecture of the preferred embodiment. All action is initiated by a user 1, who creates a user query 2. Creating a user query may be accomplished using any method or apparatus that allows user 1 to specify all of the possible parameters of the user query 2, which may include (but not be limited to) a specification of what content should be considered qualified, which search services and data stores should be accessed, whether and to what extent the webcrawling process should proceed, as well as specification of various other parameters affecting the operation of the preferred embodiment.

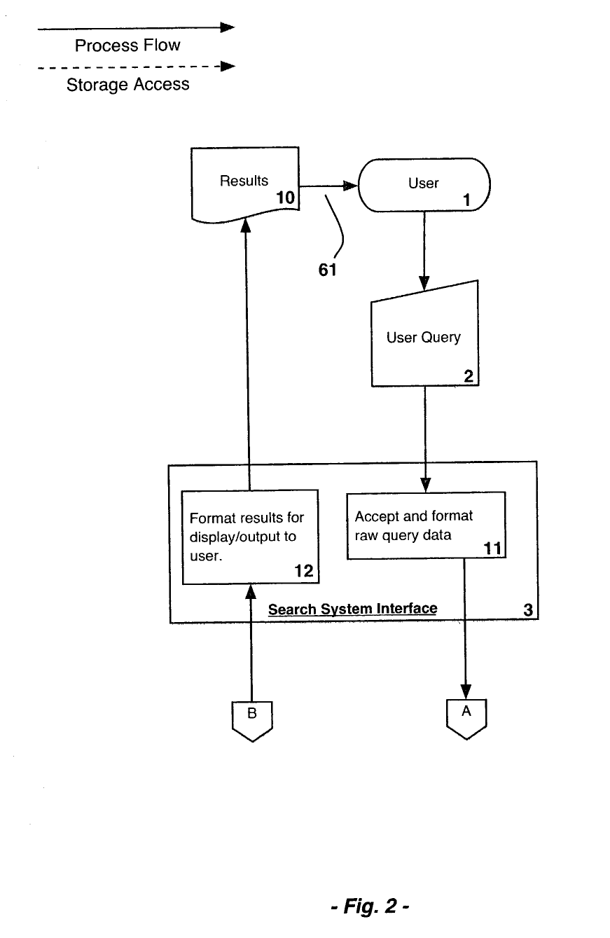

Once the user query 2 is created, it is directed to the Search System Interface (SSI) 3, the operation of which is illustrated in FIG. 2. Block 11 in the SSI 3 accepts the user query 2, and performs any formatting or pre-processing that is necessitated by the preferred embodiment's implementation prior to proceeding with the full processing of the user query 2.

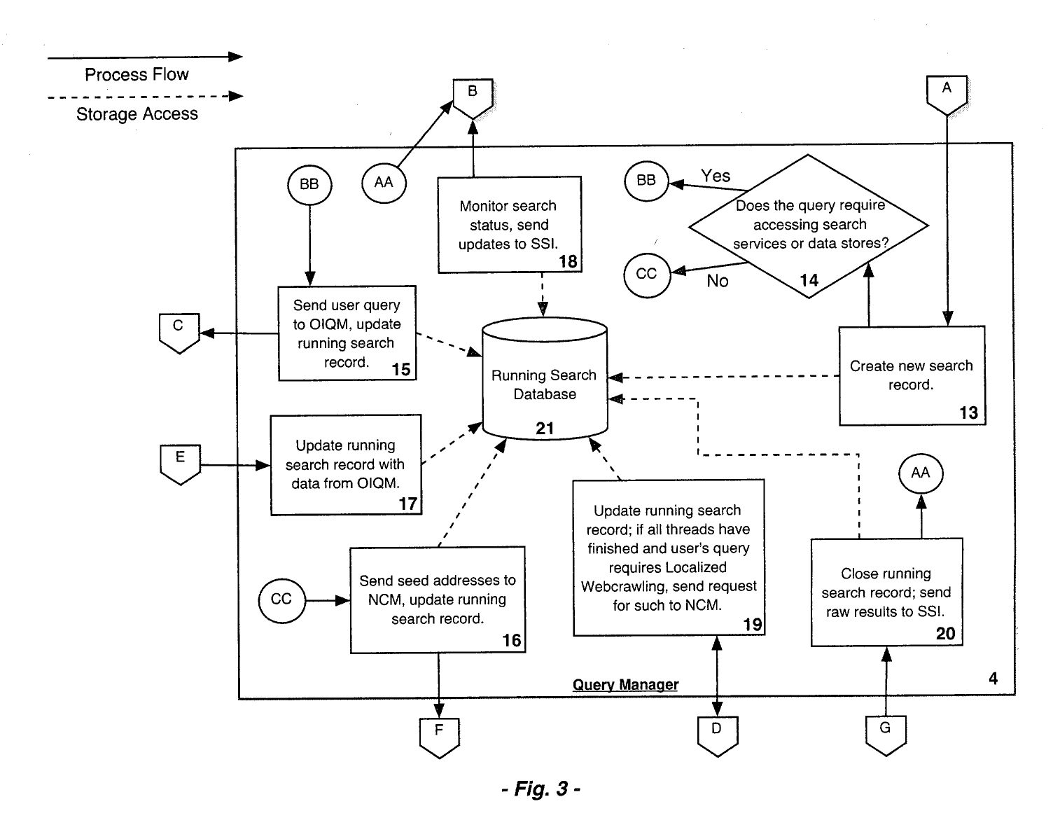

Once all such pre-processing is completed, the user query 2 is forwarded to the Query Manager (QM) 4, the operation of which is illustrated in FIG. 3. Block 13 in the QM 4 accepts the formatted user query 2, and stores it along with new status information in a new search record inside running search database 21. The status information encompasses all data related to the processing of a user query, which includes (but is not limited to) its original parameters, how many webcrawling iterations have been completed, and all data on qualified content as such becomes available.

Once block 13 has created the new search record in database 21, the user query 2 is passed to block 14, which determines whether or not the said user query's parameters require that search services and/or data stores be accessed. If a user manually entered seed addresses into the user query 2 instead of requiring that search services and/or data stores be accessed to retrieve seed addresses, processing will advance to block 16, the functionality of which is detailed below. If the user query 2 specifies that search services and/or data stores are to be accessed to retrieve seed addresses (perhaps in addition to more seed addresses entered into the user query 2 by a user), processing will advance to block 15.

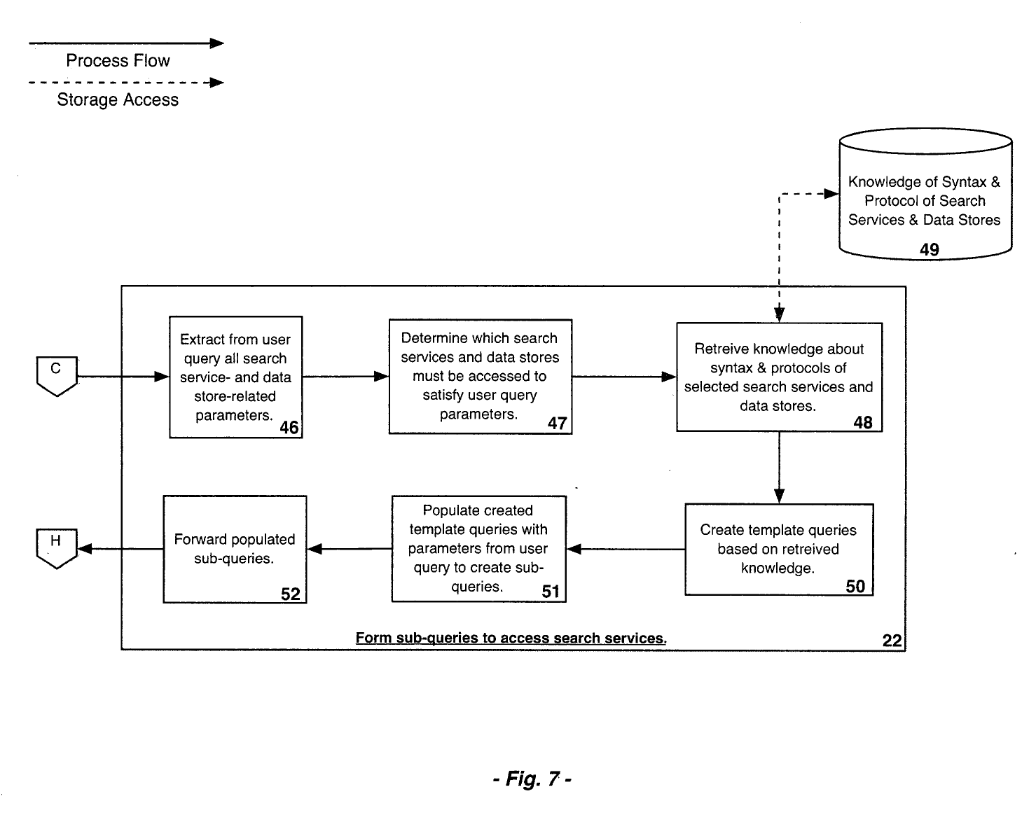

Block 15 updates the running search record created by block 13 in the database 21 to indicate that the user query 2 is being forwarded for search service and data store processing. Block 15 then forwards the user query 2 to the Outside Index Query Manager (OIQM) 5. Block 22 in the OIQM 5, the operation of which is illustrated in FIG. 7, accepts the user query 2. The user query 2 is forwarded to block 46, which extracts all parameters from said user query that relate to search service and data store operations. These parameters are forwarded to block 47, which determines specifically which search services and data stores need to be accessed in order to satisfy said parameters. Information about which search services and data stores to access is forwarded to block 48.

Database 49 contains any and all knowledge required to interface with a set of search services and data stores, of which the search services and data stores to be accessed must be a subset. This knowledge mainly (but not exclusively) consists of instructions for how to establish a communication with search services and data stores, and what content or syntax must be transmitted over said connection in order to effectively access the search services and data stores. This knowledge may be modified, created, or updated in order to allow a user query to be translated into a form appropriate for any search service or data source.

Block 48 retrieves all knowledge held in database 49 related to the search services and data stores that are to be accessed, and forwards this knowledge to block 50. Block 50 uses said knowledge to create one template query for each search service and data store that is to be accessed. All created template queries are then forwarded to block 51, which populates the template queries with user query-specific parameters to form full sub-queries. Said sub-queries are forwarded through block 52 to block 23.

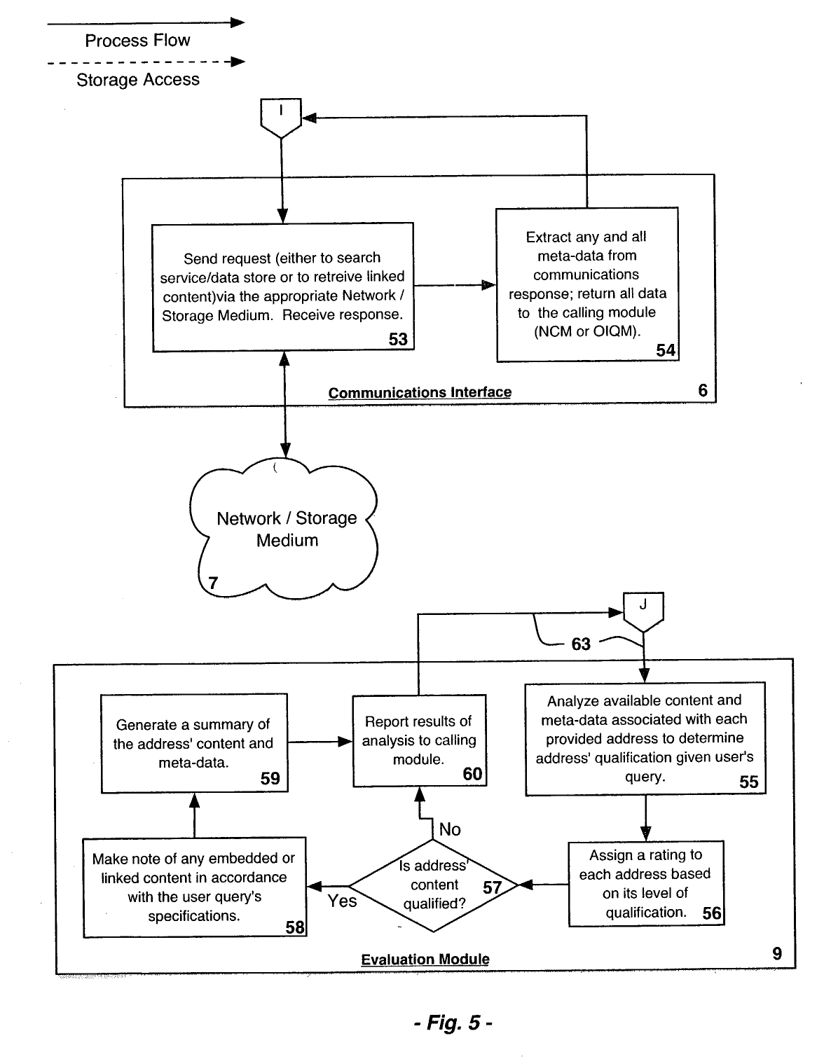

Block 23 sends each sub-query (either in turn or concurrently using threads) to block 53 in the Communications Interface 6, which is illustrated in FIG. 5. Block 53 establishes all necessary connections and operates all necessary protocols to communicate with each search service and data store over a plurality of networks and storage mediums, represented by entity 7. The sub-query created for each search service and data store is then transmitted via said connection(s) and protocol(s) to each said search service and data store. As each search service and data store respond to their respective sub-queries, block 53 receives said response, and forwards it to block 54. Block 54 extracts any and all meta-data from each response, and forwards both the meta-data and the content of each response to block 23 in the OIQM.

The content and meta-data of each search service's and data store's response is then forwarded to block 24, which extracts any and all links from said content and meta-data, and creates seed addresses with said links. When all possible seed addresses have been created using the responses of all accessed search services and data stores, said seed addresses are forwarded to block 25.

Block 25 sends a status update containing results of accessing the search services and data stores to the QM 4, which is received by block 17. Block 17 updates the running search record with said status update to reflect progress in the search, and then returns control to block 25 in the OIQM 5. Block 25 then forwards all seed addresses created from search service and data store responses to block 62.

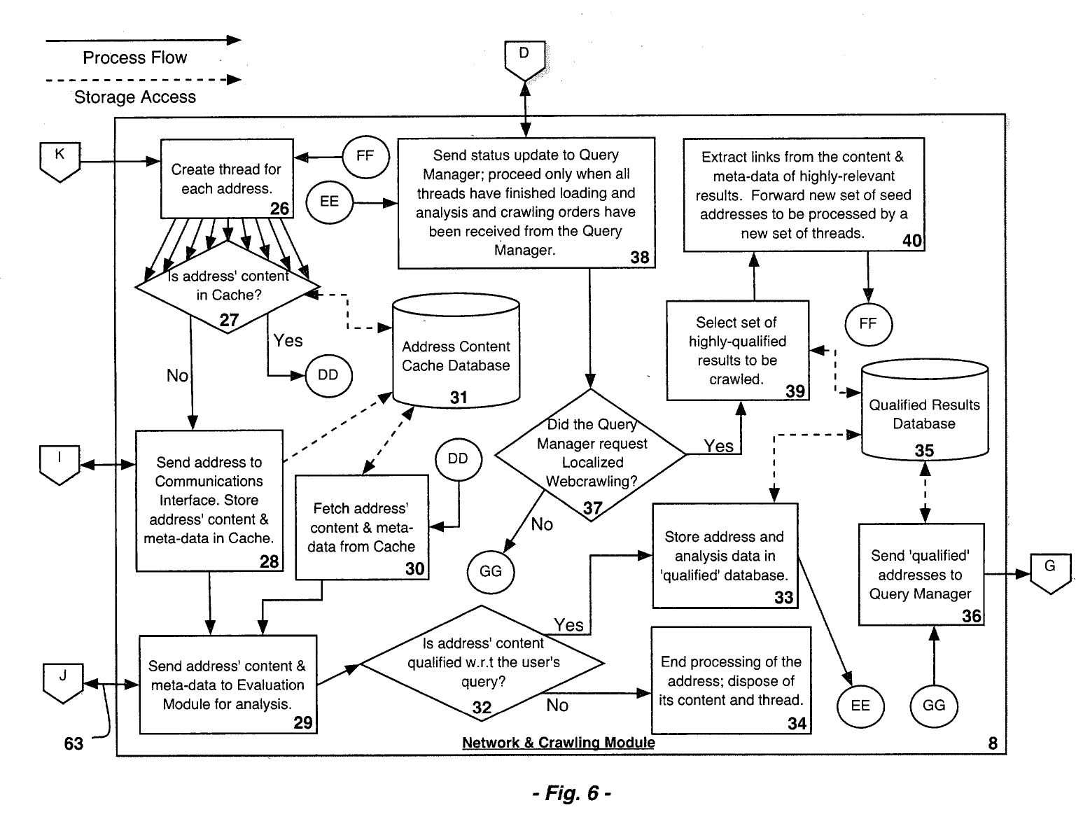

Block 62 combines received seed addresses with any and all seed addresses held by the user query 2 that were entered by the user 1 manually. This combined set of seed addresses is forwarded to the Network and Crawling Manager (NCM) 8, the operation of which is illustrated in FIG. 6, and is received by block 26.

Block 26 creates a new thread of execution for each seed address; the processing of each seed address after this point occurs concurrently along with all other seed addresses within the context of its own thread. Each seed address' thread then progresses to block 27. Database 31 acts as a caching mechanism: if the content and meta-data associated with a seed address is already stored in the cache, then said content and meta-data can be retrieved from the cache without taxing external network and other I/O channels. The oldest contents in database 31 should be purged occasionally in order to ensure that the most recent content and meta-data associated with each seed address is being utilized.

Block 27 accesses database 31 to determine if the seed address' content and meta-data are stored there. If so, the seed address' thread proceeds to block 30, where the content and meta-data associated with said seed address is retrieved from database 31, and said content and meta-data is forwarded to block 29. If the seed address' content and meta-data are not available from database 31, then the seed address' thread proceeds to block 28.

Block 28 sends the seed address to the Communications Interface 6, where its associated content and meta-data are retrieved in much the same way as search services and data stores are accessed, described earlier. When all available associated content and meta-data have been retrieved, the Communications Interface 6 returns control to block 28, which stores the newly-retrieved content and meta-data in database 31 for future use. The seed address' thread then progresses to block 29.

Block 29 forwards the seed address' content and meta-data to the Evaluation Module 9, the operation of which is illustrated in FIG. 5, and is received by block 55. The interface 63 between the Evaluation Module 9 and the NCM 8 is specifically designed to allow different modules to take the role of the Evaluation Module 9, allowing for the logistically simple customization of the evaluation process. Alternative embodiments of the current invention may therefore substitute, at a user's discretion, very different implementations of the general functions of the Evaluation Module 9.

Block 55 analyzes the received content and meta-data to determine their associated seed address' qualification with regard to the parameters stored in user query 2. The preferred embodiment's criteria for qualification is relevancy of the seed address' content and meta-data to keywords provided by the user 1, stored in the user query 2. Other implementations of the Evaluation Module 9 utilized through interface 63 may have very different criteria. Once all analysis in block 55 is concluded, control is forwarded to block 56.

Block 56 assigns a rating, which is usually but not necessarily numerical, to the seed address based on its level of qualification in accordance with user query 2. This rating is forwarded to block 57.

If the assigned qualification rating is above some threshold specified in user query 2, then block 57 will forward the seed address' content and meta-data to block 58; otherwise, control is transferred to block 60.

Block 58 in the preferred embodiment of the Evaluation Module scans the seed address' content for any embedded or linked content in accordance with the specifications in the user query 2, and makes note of the presence of any such content. For example, the user 1 may specify in the user query 2 that the presence of or links to certain types of video files should be noted and reported. The seed address' content and meta-data is then forwarded to block 59.

Block 59 generates a summary or report based on the seed address' content and meta-data, and transfers control to block 60.

Block 60 forwards all results of the Evaluation Module's analysis to block 29 in the NCM 8, which includes the qualification rating, notations of the presence of or links to any special content types specified in user query 2, and the summary or report based on the seed address' content and meta-data.

Block 32 in the NCM 8 determines if the seed address' content and meta-data are qualified with regard to the parameters stored in user query 2 based on the qualification rating returned to block 29 by block 60 in the Evaluation Module 9. If the seed address' content is not qualified, then block 34 in NCM 8 disposes of the thread processing said seed address and any system resources associated with said processing. If the seed address' content is qualified, then it and the analysis results associated with it are forwarded to block 33.

Database 35 contains records holding qualified addresses and information associated with them: their content and meta-data and the results of the analysis performed on said content and meta-data by the Evaluation Module 9. Block 33 stores the qualified seed address, its content and meta-data, and its associated analysis results in database 35, and then passes control to block 38.

Block 38 creates a status report that details the state of the NCM 8 and its processing of seed addresses associated with user query 2, including how many threads are still active. Block 38 sends this status report to block 19 in the Query Manager 4. Block 19 updates the running search record in database 21 to reflect the contents of said status report. If said status report indicates that all threads within the NCM 8 have finished processing and if user query 2 requires that localized webcrawling be utilized, then block 19 sends a request for localized webcrawling back to block 38 in the NCM 8.

When block 38 in the NCM 8 receives a response to the status report it sent to block 19 in the Query Manager 4, said response is sent to block 37.

If block 37 finds that the Query Manager's response does not include a request to conduct localized webcrawling, then control is passed to block 36. Block 36 fetches all qualified addresses, their associated content and meta-data, and the results of the analysis of said content and meta-data from database 35, and sends the entirety of those data to block 20 in the Query Manager 4.

Block 20 closes the running search record associated with user query 2 in database 21, and then forwards to block 12 in the SSI 3 the search results provided by block 36. Block 12 then formats said results, leading to the creation of a set of user-viewable—usable results (document 10). Document 10 is then sent to the user 1 via communications channel 61, which may constitute any method or pathway that can adequately relate the contents of document 10 to user 1.

If block 37 does determine that the Query Manager's response forwarded by block 38 contains a request to perform localized webcrawling, then control is passed to block 39.

Block 39 retrieves from database 35 a set of highly-qualified seed addresses whose associated content and meta-data have not yet been crawled in connection with user query 2. The content and meta-data associated with said highly-qualified seed addresses is then passed to block 40.

Block 40 extracts all available links held in the content and meta-data that are provided to it; said links are used to create a new set of seed addresses that are sent to block 26.

While a preferred embodiment of the invention has been shown in detail above, it will be understood by those skilled in the art that various changes in form and details may be effected therein without departing from the spirit and scope of the invention as specified by the appended claims.

What is claimed is:

1. A method and system for searching for information, comprising the steps of:
(a) submitting a user query to a computing device, such user query containing a set of search terms and a selection from a set of search services and data stores to be accessed in accordance with said user query via any combination of a plurality of storage and information retrieval systems and networks;
(b) translating said user query such that one or more translations of the user query are produced that can be understood and processed by the selected search services and data stores;
(c) transmitting the translated user queries to the selected search services and data stores; and
(d) retrieving the output from the selected search services and data stores generated in response to the transmission of the translated user queries.

2. A method and system as in claim 1, wherein the output retrieved from the selected search services and data stores is analyzed in accordance with the search terms included in the user query, thereby qualifying or disqualifying said output with regard to the user query.

3. A method and system as in claim 1, wherein the output retrieved from the selected search services and data stores is displayed for user examination and use.

4. A method and system as in claim 2, wherein the results of the analysis of search service and data store output are displayed for user examination and use.

5. A method and system as in claim 1, wherein said storage and information retrieval systems and networks may include but are not limited to: the World Wide Web and its associated protocols, Usenet newsgroups, private intranets, Virtual Private Networks, distributed file-sharing networks, a user's local computer system's storage devices, cellular or other wireless carrier networks, and direct database connections.

6. A method and system as in claim 3, wherein the output or displayed information is formatted using markup or display languages, including but not limited to SGML, XML, HTML, PDF, Postscript, Display Postscript, or any derivatives thereof.

7. A method and system as in claim 3, wherein a user may perform sub-queries on the form and content of any output or displayed information.

8. A method and system as in claim 4, wherein the output or displayed information is formatted using markup or display languages, including but not limited to SGML, XML, HTML, PDF, Postscript, Display Postscript, or any derivatives thereof.

9. A method and system as in claim 4, wherein a user may perform sub-queries on the form and content of any output or displayed information.

10. A method and system as in claim 3, wherein a user may perform sub-queries on the form and content of any output or displayed information.

11. A method and system as in claim 4, wherein a user may perform sub-queries on the form and content of any output or displayed information.

12. A method and system as in claim 1, wherein a selection from the set of threaded network architectures and intelligent autonomous software agents is used to parallelize the processing of each user query.

13. A method and system as in claim 3, wherein the communication channels that may be used in the presentation of said output or displayed information may include but are not limited to: through a web browser; within a window or set of windows in a desktop computer environment; via printed matter; via email or other electronic messaging; via textual output in a terminal or terminal window; via image representation; via telephone, telegraph, or teletype; or via verbal communication.

14. A method and system as in claim 4, wherein the communication channels that may be used in the presentation of said output or displayed information may include but are not limited to: through a web browser; within a window or set of windows in a desktop computer environment; via printed matter; via email or other electronic messaging; via textual output in a terminal or terminal window; via image representation; via telephone, telegraph, or teletype; or via verbal communication.

15. A method and system as in claim 1, wherein said storage and information retrieval systems and networks may include but are not limited to: the World Wide Web and its associated protocols, Usenet newsgroups, private intranets, Virtual Private Networks, distributed file-sharing networks, a user's local computer system's storage devices, cellular or other wireless carrier networks, and direct database connections.

16. A method and system as in claim 1, wherein “search services and data stores” may be a plurality of types of information services, including but not limited to: web-based search engines; paid-for or subscription search engines or libraries; web-enabled databases; databases requiring direct connections not involving web protocols; indexes or file directories stored on a user's local computer system; or indexes or file directories accessible via a network.

17. A method and system as in claim 1, wherein a user may add to, configure, or update the process used to translate a user query into a set of translated user queries appropriate for the set of selected search services and data stores.

18. A method and system as in claim 17, wherein the parameters and properties that fully describe the operation of the query translation process may be stored and retrieved between queries.

19. A method and system as in claim 17, wherein a user may modify the query translation process so that it may be used to translate future user queries for submission to new search services or data stores.

20. A method and system as in claim 19, wherein a user may select for inclusion in a user query any of the new search services or data stores.

21. A method and system as in claim 18, wherein the parameters and properties of the query translation process are stored within a selection from the group of plug-in software components and the content of configuration files.

22. A method and system as in claim 18, wherein the parameters and properties of the query translation process may be automatically retrieved, distributed, and stored based on a master set of parameters and properties.

23. A method and system as in claim 2, wherein the analysis of content and meta-data may be customized and extended whereby a user may directly or indirectly control the nature of said analysis.

24. A method and system as in claim 23, wherein the methods by which the properties and parameters of said analysis may be described include but are not limited to: user-supplied data, plug-in software components, and the content of configuration files.

25. A method and system as in claim 23, wherein the methods by which said analysis may be customized are publicly known such that persons not associated or affiliated with a vendor of an embodiment of the method and system may independently develop and distribute customized analysis processes.

26. A method and system as in claim 2, wherein the analysis of content and meta-data is capable of determining what additional types of content are linked to or embedded within said content and meta-data.

27. A method and system as in claim 26, wherein the user query includes parameters indicating which types of content should be targeted within said analysis of content and meta-data.

28. A method and system as in claim 26, wherein a user may define new types of content that may be identified in said analysis of content and meta-data, the ways in which that definition may be accomplished include but are not limited to: specifying the file extension(s) associated with the new types; specifying the meta-data typically associated with the new types; or providing examples of the new types of content so that identifying characteristics of the new types of content may be automatically determined, stored, and utilized.

29. A method and system for searching for information, comprising the steps of:
(a) submitting a user query to a computing device, such user query containing a set of search terms, a set of seed addresses, and a set of parameters defining the control of the localized webcrawling process;
(b) retrieving the content and meta-data associated with the said seed addresses via any combination of a plurality of storage and information retrieval systems and networks;
(c) analyzing said content and meta-data in accordance with the search terms included in the said user query, thereby qualifying or disqualifying said content and meta-data with regard to the user query;
(d) creating a new set of seed addresses from links extracted from the set of qualified content and meta-data; and
(e) repeating steps (b) through (d) with said new seed addresses to the extent allowed by the localized webcrawling parameters specified in the user query.

30. A method and system as in claim 29, wherein the determination in step (e) of whether to repeat steps (b) through (d) is interactively made by a user.

31. A method and system as in claim 29, wherein the results of the analysis of content and meta-data in step (c) are displayed for user examination and use.

32. A method and system as in claim 31, wherein the output or displayed information is formatted using markup or display languages, including but not limited to SGML, XML, HTML, PDF, Postscript, Display Postscript, or any derivatives thereof.

33. A method and system as in claim 31, wherein a user may perform sub-queries on the form and content of any output or displayed information.

34. A method and system as in claim 29, wherein a selection from the set of threaded network architectures and intelligent autonomous software agents is used to parallelize the processing of each user query.

35. A method and system as in claim 31, wherein the communication channels that may be used in the presentation of said output or displayed information may include but are not limited to: through a web browser; within a window or set of windows in a desktop computer environment; via printed matter; via email or other electronic messaging; via textual output in a terminal or terminal window; via image representation; via telephone, telegraph, or teletype; or via verbal communication.

36. A method and system as in claim 29, wherein said storage and information retrieval systems and networks may include but are not limited to: the World Wide Web and its associated protocols, Usenet newsgroups, private intranets, Virtual Private Networks, distributed file-sharing networks, a user's local computer system's storage devices, cellular or other wireless carrier networks, and direct database connections.

37. A method and system as in claim 29, wherein “search services and data stores” may be a plurality of types of information services, including but not limited to: web-based search engines; paid-for or subscription search engines or libraries; web-enabled databases; databases requiring direct connections not involving web protocols; indexes or file directories stored on a user's local computer system; or indexes or file directories accessible via a network.

38. A method and system as in claim 29, wherein the user query submitted in step (a) may explicitly include a set of seed addresses, which are added to the set of seed addresses created in step (d).

39. A method and system as in claim 29, wherein a user may add to, configure, or update the process used to translate a user query into a set of translated user queries appropriate for the set of selected search services and data stores.

40. A method and system as in claim 39, wherein the parameters and properties that fully describe the operation of the query translation process may be stored and retrieved between queries.

41. A method and system as in claim 39, wherein a user may modify the query translation process so that it may be used to translate future user queries for submission to new search services or data stores.

42. A method and system as in claim 41, wherein a user may select for inclusion in a user query any of the new search services or data stores.

43. A method and system as in claim 40, wherein the parameters and properties of the query translation process are stored within a selection from the group of plug-in software components and the content of configuration files.

44. A method and system as in claim 40, wherein the parameters and properties of the query translation process may be automatically retrieved, distributed, and stored based on a master set of parameters and properties.

45. A method and system as in claim 29, wherein the analysis of content and meta-data may be customized and extended whereby a user may directly or indirectly control the nature of said analysis.

46. A method and system as in claim 45, wherein the methods by which the properties and parameters of said analysis may be described include but are not limited to: user-supplied data, plug-in software components, and the content of configuration files.

47. A method and system as in claim 45, wherein the methods by which said analysis may be customized are publicly known such that persons not associated or affiliated with a vendor of an embodiment of the method and system may independently develop and distribute customized analysis processes.

48. A method and system as in claim 29, wherein the analysis of content and meta-data is capable of determining what additional types of content are linked to or embedded within said content and meta-data.

49. A method and system as in claim 48, wherein the user query includes parameters indicating which types of content should be targeted within said analysis of content and meta-data.

50. A method and system as in claim 48, wherein a user may define new types of content that may be identified in said analysis of content and meta-data, the ways in which that definition may be accomplished include but are not limited to: specifying the file extension(s) associated with the new types; specifying the meta-data typically associated with the new types; or providing examples of the new types of content so that identifying characteristics of the new types of content may be automatically determined, stored, and utilized.

51. A method and system for searching for information, comprising the steps of:
(a) submitting a user query to a computing device, such user query containing a set of search terms, a selection of a set of search services and data stores to be accessed in accordance with such user query via any combination of a plurality of storage and information retrieval systems and networks, and a set of parameters defining the control of the localized webcrawling process;
(b) translating said user query such that one or more translations of the user query are produced that can be understood and processed by the selected search services and data stores;
(c) transmitting the translated user queries to the selected search services and data stores;
(d) retrieving the output from the selected search services and data stores generated in response to the transmission of the translated user queries.
(e) creating a new set of seed addresses from links extracted from the output of the selected search services and data stores;
(f) retrieving the content and meta-data associated with the said seed addresses via any combination of a plurality of storage and information retrieval systems and networks;
(g) analyzing said content and meta-data with regard to the search terms included in the said user query, thereby qualifying or disqualifying said content and meta-data with regard to the user query;
(h) creating a new set of seed addresses from links extracted from the set of qualified content and meta-data; and
(i) repeating steps (f) through (h) with said new seed addresses to the extent allowed by the localized webcrawling parameters specified in the user query.

52. A method and system as in claim 51, wherein the determination in step (i) of whether to repeat steps (f) through (h) is interactively made by a user.

53. A method and system as in claim 51, wherein the results of the analysis of content and meta-data in step (g) are displayed for user examination and use.

54. A method and system as in claim 53, wherein the output or displayed information is formatted using markup or display languages, including but not limited to SGML, XML, HTML, PDF, Postscript, Display Postscript, or any derivatives thereof.

55. A method and system as in claim 53, wherein a user may perform sub-queries on the form and content of any output or displayed information.

56. A method and system as in claim 51, wherein a selection from the set of threaded network architectures and intelligent autonomous software agents is used to parallelize the processing of each user query.

57. A method and system as in claim 51, wherein the communication channels that may be used in the presentation of said output or displayed information may include but are not limited to: through a web browser; within a window or set of windows in a desktop computer environment; via printed matter; via email or other electronic messaging; via textual output in a terminal or terminal window; via image representation; via telephone, telegraph, or teletype; or via verbal communication.

58. A method and system as in claim 51, wherein said storage and information retrieval systems and networks may include but are not limited to: the World Wide Web and its associated protocols, Usenet newsgroups, private intranets, Virtual Private Networks, distributed file-sharing networks, a user's local computer system's storage devices, cellular or other wireless carrier networks, and direct database connections.

59. A method and system as in claim 51, wherein “search services and data stores” may be a plurality of types of information services, including but not limited to: web-based search engines; paid-for or subscription search engines or libraries; web-enabled databases; databases requiring direct connections not involving web protocols; indexes or file directories stored on a user's local computer system; or indexes or file directories accessible via a network.

60. A method and system as in claim 51, wherein the user query submitted in step (a) may explicitly include a set of seed addresses, which are added to the set of seed addresses created in step (e).

61. A method and system as in claim 51, wherein a user may add to, configure, or update the process used to translate a user query into a set of translated user queries appropriate for the set of selected search services and data stores.

62. A method and system as in claim 61, wherein the parameters and properties that fully describe the operation of the query translation process may be stored and retrieved between queries.

63. A method and system as in claim 61, wherein a user may modify the query translation process so that it may be used to translate future user queries for submission to new search services or data stores.

64. A method and system as in claim 63, wherein a user may select for inclusion in a user query any of the said new search services or data stores.

65. A method and system as in claim 62, wherein the said parameters and properties of the query translation process are stored within a selection from the group of plug-in software components and the content of configuration files.

66. A method and system as in claim 62, wherein the parameters and properties of the query translation process may be automatically retrieved, distributed, and stored based on a master set of parameters and properties.

67. A method and system as in claim 51, wherein the analysis of content and meta-data may be customized and extended whereby a user may directly or indirectly control the nature of said analysis.

68. A method and system as in claim 67, wherein the methods by which the properties and parameters of said analysis may be described include but are not limited to: user-supplied data, plug-in software components, and the content of configuration files.

69. A method and system as in claim 67, wherein the methods by which said analysis may be customized are publicly known such that persons not associated or affiliated with a vendor of an embodiment of the method and system may independently develop and distribute customized analysis processes.

70. A method and system as in claim 51, wherein the analysis of content and meta-data is capable of determining what additional types of content are linked to or embedded within said content and meta-data.

71. A method and system as in claim 70, wherein a user may define new types of content that may be identified within said analysis process.

72. A method and system as in claim 70, wherein a user may define new types of content that may be identified in said analysis process, the ways in which that definition may be accomplished include but are not limited to: specifying the file extension(s) associated with the new types; specifying the meta-data typically associated with the new types; or providing examples of the new types of content so that identifying characteristics of the new types of content may be automatically determined, stored, and utilized.
